(19) United States
(12) Patent Application Publication
(10) Pub. No.: US 2010/0140186 A1
(43) Pub. Date: Jun. 10, 2010

(54) Acrylamide Removal from Aqueous Fluid Bodies

(75) Inventors: Shurong Huang, Houston, TX (US); John M. Rovison, JR., Sanborn, NY (US)

Correspondence Address: PATENT ADMINISTRATOR;FMC CORPORATION, 1735 MARKET STREET, PHILADELPHIA, PA, 19103, US

(73) Assignee: FMC CORPORATION, Philadelphia, PA (US)

(21) Appl. No.: 12/631,120

(22) Filed: Dec. 4, 2009

Related U.S. Application Data
(60) Provisional application No. 61/201,276, filed on Dec. 9, 2008.

(51) Int. Cl. C02F 1/72; C09K 8/60

(52) U.S. Cl. 210/759; 507/219

(57) ABSTRACT

This invention is a method for removing acrylamide from large bodies of water or from other acrylamide-containing aqueous fluids. The acrylamide-containing water or aqueous fluid is treated with a peroxygen that is preferably persulfate, hydrogen peroxide or activated peracetic acid. The invention is particularly useful for treatment of acrylamide-containing aqueous fluids associated with oil and gas drilling and recovery applications and includes aqueous well treatment fluid compositions comprising an acrylamide-derived polymer and a peroxygen compound capable of generating free radicals, useful in slickwater well treatment applications.

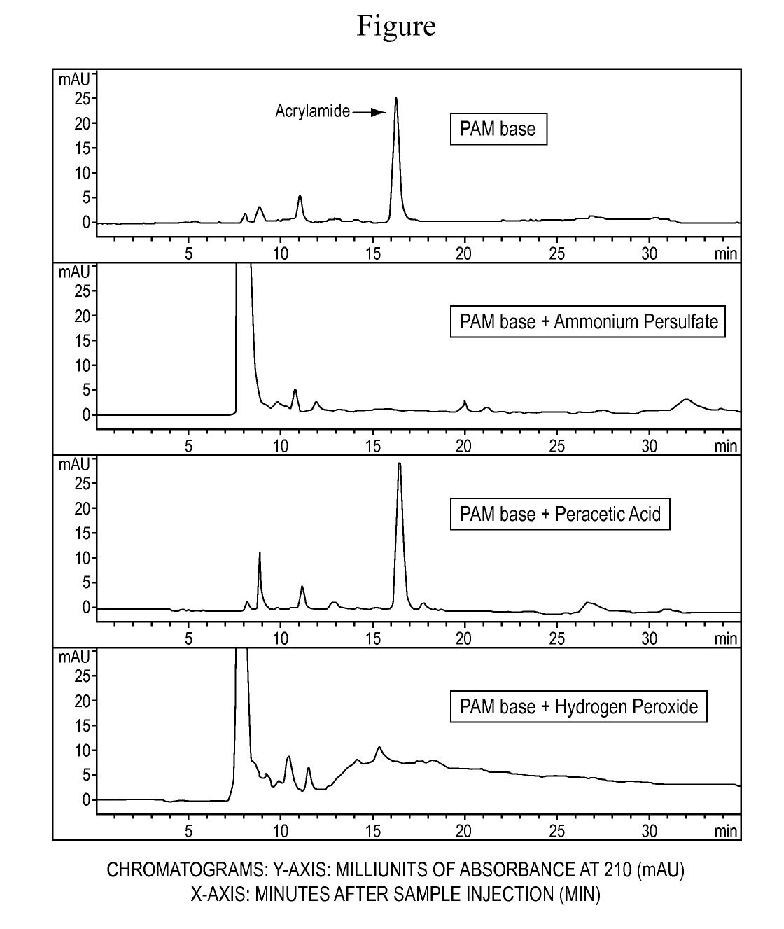

### FIELD OF THE INVENTION

The present invention relates to a method for removing acrylamide from large bodies of water or other acrylamide-containing aqueous fluids.

### BACKGROUND OF THE INVENTION

In oil and gas drilling and well field applications, polyacrylamide polymer and copolymer products have been widely used for decades to enhance or modify the characteristics of the aqueous fluids used in such applications.

One example of such use is for friction reduction in water or other water-based (aqueous) fluids used for hydraulic fracturing treatments in subterranean well formations. Hydraulic “frac” or “fracking” treatments create fluid-conductive cracks or pathways in the subterranean rock formations in gas- and/or oil-producing zones, improving permeability of the desired gas and/or oil being recovered from the formation via the wellbore.

“Slick water” fluids are water or other aqueous fluids that typically contain a friction-reducing agent to improve the flow characteristics of the aqueous fluid being pumped via the well into the gas- and/or oil-producing zones, whether for fracturing or other treatments. The friction reduction agents are usually polymers, and polyacrylamide polymers and copolymers are among the most widely used polymers for this purpose.

Acrylamide-based or acrylamide-derived polymers and copolymers that have utility in oil and gas field applications include polyacrylamide (sometime abbreviated as PAM), acrylamide-acrylate copolymers, including partially hydrolyzed polyacrylamide copolymers (PHPA), acrylamide-methyl-propane sulfonate copolymers (AMPS) and the like. Such copolymers include acrylic acid-acrylamide copolymers, acrylic acid-methacrylamide copolymers, partially hydrolyzed polyacrylamides, partially hydrolyzed polymethacrylamides and the like. Acrylamide-based polymers and copolymers have also been described in the patent literature, e.g., U.S. Pat. No. 3,254,719 of Root (Dow Chemical) and U.S. Pat. No. 4,152,274 of Phillips et al. (Nalco Chemical), for use as friction reducers in oil field applications such as well fracturing.

Examples of commercial acrylamide-based polymer products include New-Drill® products (Baker Hughes, Houston, Tex.), FRW-15 friction reducer (BJ Services, Houston, Tex.), and FR56™ friction reducer (Halliburton, Houston, Tex.).

Another use of acrylamide polymers and copolymers in oil and/or gas field applications is in cross-linked form, e.g., to promote formation of water-soluble, reversible gels in well treatment fluids, particularly those used to inhibit or control flow of water or formation gas and/or oil products into the well bore. Such cross-linked acrylamide-based polymers have been described in U.S. Pat. No. 4,995,461 of Sydansk (Marathon Oil) and in U.S. Pat. No. 5,268,112 of Hutchins et al. (Union Oil of California).

The Sydansk '461 patent teaches that the cross-linked polymer gels of its invention are generally reversible and that residual polymer gel may be removed by reversing the gelation with a conventional “breaker” such as peroxides, hypochlorites or persulfates (col. 9, lines 13-18 and Example 10.)

One drawback of the use of acrylamide-based polymers in bodies of water present in the environment is that their decomposition byproducts, whether such decomposition is induced or occurs naturally, may include acrylamide monomer. Acrylamide (monomer) is a known environmental hazard that is highly mobile in aqueous environments and that is readily leachable from soil.

The International Agency for Research on Cancer has categorized acrylamide as probably carcinogenic to humans (“Acrylamide in Drinking-water”, World Health Organization Report WHO/SDE/WSH/03.04/71, pp. 6-7 (2003)). Conventional drinking water treatment processes are typically ineffective for removing acrylamide (WHO Report, supra). Acrylamide may be removed from acrylamide-contaminated water via ozonation or treatment with potassium permanganate (WHO Report, supra), but these procedures are not economically feasible or readily adapted to subterranean treatment of large bodies of acrylamide-contaminated aqueous fluid.

Techniques for minimizing the presence of acrylamide monomer in polymer products, following polymerization of acrylamide-derived polymers, have been described in the literature. Representative techniques include treatment of the polymer mixture with an alkali metal bisulfate, sulfite, metabisulfite, pyrosulfite or sulfur dioxide, and treatment with amidase enzyme. However, these monomer reduction techniques still leave a residual monomer concentration in the polymer product, on the order of 10-300 ppm or more acrylamide monomer.

The presence of acrylamide (monomer) in aqueous bodies of water or other aqueous fluids, whether subterranean or surface, is undesirable where such acrylamide-containing aqueous water bodies have the potential to contaminate groundwater, surface water or other drinking water sources. Treatment of such large bodies of water or other aqueous fluid is complicated by their large volumes, which are typically millions of liters or gallons. The present invention provides a method for reducing or removing acrylamide from acrylamide-containing bodies of water or other aqueous fluids, whether subterranean or surface.

### BRIEF SUMMARY OF THE INVENTION

One embodiment of the present invention is a method for removing acrylamide in an aqueous fluid body comprising contacting an aqueous fluid body contaminated with acrylamide with an aqueous treatment composition containing a peroxygen compound capable of generating free radicals for a period of time sufficient to remove at least a portion of the acrylamide in the untreated aqueous fluid.

Another embodiment of the present invention is a method for removing acrylamide in a well treatment aqueous fluid comprising contacting a well treatment aqueous fluid containing an acrylamide-derived polymer with a peroxygen compound capable of generating free radicals for a period of time sufficient to remove at least a portion of acrylamide present or formed in the untreated aqueous fluid.

Still another embodiment of the present invention is an aqueous well treatment fluid composition comprising an acrylamide-derived polymer and a peroxygen compound capable of generating free radicals, the peroxygen compound being present in an amount sufficient to remove acrylamide present or formed in a subterranean aqueous fluid body. A preferred aqueous composition of this invention is a slickwater well treatment fluid containing an acrylamide-derived polymer as a friction reducer.

The peroxygen compound capable of generating free radicals is preferably selected from the group consisting of ammonium persulfate, potassium persulfate, sodium persulfate, activated peracetic acid, hydrogen peroxide and combinations of these.

### BRIEF DESCRIPTION OF THE DRAWING

The FIGURE shows chromatogram results of HPLC analyses for treatments of an acrylamide-containing and polyacrylamide-containing aqueous solution with three peroxygens, ammonium persulfate, peracetic acid and hydrogen peroxide, in an evaluation of these peroxygens for their efficacy in acrylamide removal.

### DETAILED DESCRIPTION OF THE INVENTION

The present invention provides a straightforward, effective and simple approach for removing acrylamide monomer from acrylamide-contaminated aqueous bodies of water or other aqueous fluids. The invention has the advantage of effecting efficient removal of acrylamide without introducing other undesirable compounds or chemicals into the acrylamide-containing aqueous fluid body. The invention provides an efficient and economic means for removing acrylamide from large bodies of acrylamide-contaminated water or other aqueous fluid, regardless of whether the acrylamide is present at very low concentrations or is a significant contaminant at higher concentrations.

### Acrylamide

Acrylamide monomer in bodies of water or other large aqueous bodies can originate from any number of sources. The presence of acrylamide in water supplies or water bodies that are potentially usable for human or animal consumption has increasingly become recognized as undesirable, even in residual amounts or low concentrations, as noted earlier.

Acrylamide-derived polymers may contain residual amounts of acrylamide monomer, which can be carried along into the end-use applications of the polymer and become leached into water bodies in such applications. The principal uses of acrylamide-derived polymers, particularly polyacrylamide, are in flocculation treatment (clarification) of municipal water supplies or municipal or industrial waste water, and as additives used in oil/gas well treatment aqueous media. Acrylamide can also contaminate or otherwise be present in water bodies through other end uses since acrylamide-derived polymers have widespread industrial uses, e.g., in wastepaper recycling, in paints and coatings, sewer grouting, and the like.

In some circumstances, polyacrylamide or other acrylamide-derived polymers can degrade or otherwise depolymerize in a manner that leads to some formation of acrylamide monomer. Degradation of acrylamide-derived polymers can occur from exposure to strong light or UV (ultraviolet) light or other polymer-degrading agents, resulting in formation of acrylamide monomer, typically in small but measurable amounts.

### Acrylamide Concentration

The present invention is directed to the removal of acrylamide from an acrylamide-containing aqueous fluid body, as well as control of acrylamide formation in such water bodies. The acrylamide-containing or contaminated aqueous fluid body may also contain polyacrylamide polymer or other acrylamide-derived polymer or copolymer. As noted above, acrylamide-derived polymers, including copolymers, can be significant source of acrylamide residues in water bodies.

References in the present specification to acrylamide in the context of the present invention are intended to mean acrylamide monomer, not acrylamide-derived polymer or copolymer. As used in the present specification, removal or removing refers both to the partial reduction in the initial acrylamide concentration and to the essentially complete removal of the acrylamide from the aqueous fluid body being treated.

The acrylamide content or concentration in the water body or other aqueous fluid body requiring acrylamide removal treatment may be very small or dilute, e.g., about 1 ppm or even lower concentrations. Residual, dilute concentrations of at least about 5 ppm or at least about 10 ppm or higher may also be treated in the method of this invention. The treatment method of this invention is equally applicable to, and equally efficacious with, more significant concentrations of acrylamide in the water body or other aqueous fluid body, e.g., at least 50 ppm or at least 100 ppm or at least 500 ppm or higher.

The acrylamide removal may be a partial reduction, such that there is removal of a significant portion of the acrylamide present, e.g., a reduction to less than half (less than about 50%) of the initial acrylamide concentration. More preferably, the acrylamide removal that is effected is a reduction of at least about 80% of the initial acrylamide present in the aqueous fluid being treated. The present invention can remove essentially all of the acrylamide initially present, i.e., reducing the acrylamide concentration to less than about 1 ppm acrylamide after treatment. Such complete removal, i.e., reduction of the acrylamide concentration such that essentially no residual acrylamide is present, e.g., to a concentration of less than about 1 ppm acrylamide, is most preferred in the method of the present invention.

### Body of Water or Aqueous Fluid

The aqueous water bodies or bodies of other aqueous fluid or aqueous media that contain or are otherwise contaminated with acrylamide and that are treated according to the present invention are characterized by being substantial in size. These large bodies may be located on the earth's surface, e.g., being a lake, pond, retention basin, reservoir, or water treatment facility, or an open or closed storage vessel, containing acrylamide-containing surface water or other acrylamide-containing aqueous medium, or the like.

The large body of water or other aqueous fluid may also be subterranean, being located below the surface of the earth, e.g., groundwater, aquifers, underground flowing water, or other below-ground natural water body. The subterranean body of aqueous fluid may also be man-made, e.g., a body of aqueous drilling fluid or other aqueous fluid used in connection with oil and/or gas drilling, recovery, production enhancement, or like treatment, that is located below the surface. The present invention is particularly preferred for treatment of acrylamide-containing subterranean aqueous fluid bodies associated with or used in connection with oil and/or gas field operations.

A common characteristic or feature of the water or aqueous fluid bodies treated in this invention is that these aqueous bodies are large in volume, i.e., at least 10³ gallons or more typically at least 10⁴ gallons or even 10⁵ gallons or more in volume. In the present specification, the term water body or body of aqueous fluid or the like is intended to mean a volume of water or other aqueous fluid requiring treatment for removal of acrylamide that is at least 1000 (10³) gallons in volume and, more typically, that is at least 10,000 (10⁴) gallons in volume.

The present invention is particularly suited for the efficient and economic treatment of these large bodies of water or other aqueous fluid, unlike laboratory-scale acrylamide treatment procedures which cannot realistically or economically be scaled up for remediation of acrylamide-containing water bodies requiring treatment outside of the laboratory.

### Peroxygens

The inventors have unexpectedly discovered that certain peroxygen compounds are highly effective in removing acrylamide from aqueous bodies of water or other aqueous fluids. The peroxygen compound, also called a peroxygen in this specification, is a peroxygen that is capable of producing free radicals in an aqueous medium. The peroxygen employed in this invention is preferably selected from the group of peroxygen compounds consisting of, but not limited to, persulfates, hydrogen peroxide (including compounds that produce hydrogen peroxide in an aqueous medium), and activated peracetic acid.

The utility in the present invention of peroxygens for removing acrylamide monomer from aqueous bodies also containing polyacrylamide or other acrylamide-derived polymers is noteworthy and surprising, for the following reason. Persulfates and hydrogen peroxide are known to be useful in degrading polyacrylamide, i.e., an acrylamide polymer, used in high viscosity or gelling applications in oil and gas field well treatments, the persulfate or hydrogen peroxide functioning as “breakers” after the polymer has served its purpose. Such breakers are believed to result in the formation of shorter polymeric chain fragments when the polyacrylamide is degraded.

### Persulfates

Persulfates are a preferred peroxygen for use in the method of the present invention. The persulfate may be selected from peroxymonosulfates (monopersulfates) and peroxydisulfates (dipersulfates). The persulfate is preferably an inorganic persulfate and is preferably a peroxydisulfate. Preferred persulfates include ammonium persulfate ((NH₄)₂S₂O₈) and alkali metal persulfates, particularly, sodium persulfate (Na₂S₂O₈) and potassium persulfate (K₂S₂O₈). Combinations of these persulfates or of a persulfate with another other suitable peroxygen may be used. The persulfate is preferably at least partially soluble in an aqueous medium, i.e., being at least partially water soluble.

Commercially-available ammonium, sodium and potassium persulfates are produced in the form of a dry white crystalline powder that is odorless. These persulfates are strong oxidizing agents that find use in many industrial processes and commercial products, with their primary applications being as oxidants in cleaning, microetching, and plating processes and as catalysts or initiators in polymerization processes, including acrylamide polymerization processes.

### Hydrogen Peroxide & H₂O₂-Generating Compounds

Hydrogen peroxide may also be used in this invention as the peroxygen for removing acrylamide from aqueous bodies of water or from other acrylamide-containing aqueous fluids. Hydrogen peroxide (H₂O₂) is a clear colorless liquid that is slightly more dense than water; hydrogen peroxide is a weak acid.

Hydrogen peroxide is miscible with water in all proportions and is available commercially at a wide range of concentrations, as concentrated aqueous solutions, e.g., 20 or 35 wt % H₂O₂ and higher, as well as more dilute aqueous solutions of about 3 wt % up to about 20 wt % H₂O₂.

Commercial formulations of aqueous hydrogen peroxide may be used in the present invention, with such formulations being diluted to a hydrogen peroxide concentration appropriate for treatment of the acrylamide-containing water body or aqueous fluid body.

The hydrogen peroxide may alternatively be produced in situ in the aqueous medium from a hydrogen peroxide-generating source, e.g., a solid peroxygen compound that is a hydrogen peroxide source, introduced into the aqueous medium. Such hydrogen peroxide-generating solid compounds are characterized by their ability to generate the required hydrogen peroxide, as a decomposition product or the like, when introduced into or when dissolved or otherwise present in an aqueous medium.

The hydrogen peroxide-generating peroxygen compounds may be one or more solid peroxygen compounds. Examples include without limitation percarbonates like sodium percarbonate, perborates like sodium perborate, peroxides like sodium, magnesium, calcium, lithium or zinc peroxide, peroxyurea compounds like urea peroxide, persilic acid, hydrogen peroxide adducts of pyrophosphates and phosphates like sodium phosphate perhydrate, and hydrogen peroxide adducts of citrates and sodium silicate, and the like, and mixtures thereof

### Peracetic Acid—Activated

Peracetic acid, activated with a suitable activator, catalyst, initiator or its equivalent, is another peroxygen that is effective for removing acrylamide from water bodies or other aqueous fluid in the method of this invention.

Peracetic acid, sometimes called peroxyacetic acid or PAA, is a well known chemical for its strong oxidizing potential. Peracetic acid has a molecular formula of C₂H₄O₃ or CH₃COOOH.

Peracetic acid is a liquid with an acrid odor and is normally sold in commercial formulations as aqueous solutions typically containing, e.g., 5, 15 or 35 wt % peracetic acid. Such aqueous formulations not only contain peracetic acid but also hydrogen peroxide (e.g., 7-25 wt %) and acetic acid (e.g., 6-39 wt %) in a dynamic chemical equilibrium. Any of these commercial formulations of aqueous peracetic acid may be used in the present invention, being diluted to a peracetic acid concentration appropriate for treatment of the acrylamide-containing water body or aqueous fluid body.

The inventors have unexpectedly discovered that peracetic acid is another peroxygen useful in the present invention, when peracetic acid is used in combination with a peroxide activator, i.e., activated peracetic acid. In the absence of a peroxygen activator, peracetic acid is generally ineffective for removing acrylamide from an acrylamide-contaminated aqueous solution. The inventors have found that the addition or presence of a peroxygen activator, e.g., a catalyst, initiator or its equivalent, with the peracetic acid makes peracetic acid highly effective in removing acrylamide.

A peroxygen activator may also optionally be used with persulfate or hydrogen peroxide in this invention to provide enhanced peroxygen reactivity in removing the acrylamide in the water or aqueous fluid body being treated. Use of a peroxygen activator with a persulfate or hydrogen peroxide may be desirable in situations where the temperature of the aqueous fluid is not elevated, e.g., above about 40° C., or where more rapid reactivity is sought, or where lower concentrations of the peroxygen are employed, or other less-than-optimal peroxygen reaction conditions are present.

The peroxygen activator that is used with peracetic acid in this invention and that may optionally be used with persulfates and/or hydrogen peroxide, is an element or compound or combinations that is conventionally used as a peroxide compound or hydrogen peroxide activator. Peroxide activators are also sometimes called peroxide catalysts or peroxide initiators. Preferred peroxygen activators are those that are highly active in catalyzing the formation of free radicals.

Among the preferred peroxygen activators are the transition metals. The transition metals commonly include the elements in the d-block of the periodic table, including zinc, cadmium and mercury. The transition metals thus correspond to groups 3 to 12 in the periodic table. The transition metals therefore include the first transition series, comprising the elements Sc, Ti, V, Cr, Mn, Fe, Co, Ni, Cu, the second transition series, comprising the lanthanides, and the third transition series, comprising the actinides.

The transition metal peroxygen activators may be in the form of elemental metal, complexed metals or metal compounds. Preferred peroxygen initiators include iron (Fe), titanium (Ti), manganese, silver and transition metal compounds like manganese dioxide. Combinations of these activators, e.g., iron and copper, are also effective as peroxygen activators. Iron is a preferred peroxygen activator, particularly for use in combination with peracetic acid, i.e., activated peracetic acid.

The peroxygen activator may be added to the peracetic acid or other peroxygen treatment solution or may be otherwise combined with the peroxygen to be in proximity of the peroxygen and be effective as activator. The peroxygen activator is typically used in amounts well known to those skilled in the art of activating peroxygens. By way of example, the transition metal activator is typically added in an amount of about 0.1 to about 20% of the weight of the peroxide, but this amount can be increased or decreased outside of this range according to the actual circumstances (temperature, specific activator employed, etc.)

Alternatively or in addition, a peroxygen initiator may be already present in the body of acrylamide-contaminated aqueous fluid being treated. For example, aqueous well drilling fluids injected or otherwise introduced into a gas- and/or oil producing formation may contain a peroxygen activator, e.g., iron, as a component specifically added to the well fluid for other well production purposes. Likewise, a subterranean body of aqueous fluid may contain one or more transition metals (including transition metal compounds) that are introduced (via solubilization, leaching or the like) into the fluid as result of the body of aqueous fluid's exposure or contact with minerals or mineral-bearing components (e.g., iron-containing components), in a subterranean formation where the fluid body is located.

Other peroxygen initiators may also be employed in this invention in conjunction with the peroxygen compound, e.g., initiators such as tetramethylethylenediamine (TEMED) or other like amines or ammonia being particularly useful with persulfates. In addition to compounds or metals that serve as peroxygen initiators, physical conditions such as temperature or pH can also be employed as an initiating agent in some circumstances.

### Peroxygen Treatment Concentration

The acrylamide treatment method of this invention may be used with a broad range of peroxygen concentrations. The peroxygen treatment concentration refers in this specification to the concentration of peroxygen effectively present in the treated acrylamide-containing aqueous fluid body, once the peroxygen compound has been intimately contacted with or dispersed in the fluid being treated. This peroxygen treatment concentration is calculated on the assumption that no reaction has yet occurred between the peroxygen and acrylamide-containing treated fluid.

The peroxygen concentration is selected and/or adjusted to provide at least about 1 ppm peroxygen compound, and preferably at least about 5 ppm and more preferably at least about 10 ppm peroxygen compound in the treated fluid and most preferably at least about 100 ppm peroxygen compound in the treated fluid (before acrylamide reaction). The peroxygen concentrations below 100 ppm are relatively dilute but are still capable of excellent acrylamide removal efficiencies, particularly at elevated treatment temperatures.

Since the bodies of water or aqueous fluid being treated are normally large, the peroxygen concentration is desirably minimized consistent with still achieving rapid peroxygen reaction with the acrylamide and the desired degree of acrylamide removal. The peroxygen concentration used in the treatment method of this invention is preferably less than about 1 wt % (10,000 ppm) peroxygen compound, more preferably less than about 0.5 wt % (5000 ppm) peroxygen compound, and most preferably less than about 0.1 wt % (1000 ppm) peroxygen compound, all concentrations being the calculated (theoretical) amount of peroxygen in the treated fluid (before reaction of the peroxygen with the acrylamide).

### Treatment/Contact Techniques

The contacting of the peroxygen compound treatment composition with the aqueous fluid body being treated may involve direct mixing, where feasible, or introduction of the peroxygen compound treatment composition into the aqueous fluid body with diffusion of the peroxygen compound being allowed to take place. Conventional mixing techniques are best suited for treatment of surface-located aqueous fluid bodies.

Subterranean or other subsurface aqueous bodies are more suitably treated with the peroxygen-containing treatment composition by well injection or pumping to effect diffusive mixing or by localized mixing and treatment of a portion of the aqueous fluid body, e.g., treatment of that portion of subterranean fluid that is being withdrawn from the subterranean location. Another approach is treatment via an injection well at one end or location of the aqueous body and removal of the treated fluid being effected from another well located some distance from the injection well, the treated fluid thus having to travel the distance between the wells. This latter approach facilitates a lengthy contact or residence time in the treatment step.

The treatment time, i.e., the period of time required for the peroxygen to effect removal of acrylamide in the treated fluid body after the peroxygen is introduced into contact with the acrylamide-containing fluid, may range from a few minutes (provided good mixing between the peroxygen compound and aqueous medium is achieved) to less than about one hour. Treatment times (also called residence times or contact times) of several hours or longer are appropriate where mixing of the peroxygen compound throughout the aqueous medium being treated is less than optimum. The residence or contact time employed is typically affected by the treatment temperature (with elevated temperatures providing faster reactivity), peroxygen concentration (higher concentrations providing faster reactivity), acrylamide concentration and the efficiency of mixing of the peroxygen compound throughout the acrylamide-containing aqueous medium being treated.

Generally, the treatment time (contact or residence time) should be at least about five minutes and is preferably at least about one hour, where good or efficient mixing between the peroxygen and the treated aqueous medium is obtained. The treatment time should be longer where there is less than optimum mixing or distribution of the peroxygen throughout the aqueous medium being treated, in such cases preferably at least 3 hours, more preferably at least 10 hours. In the treatment of large volumes of subterranean aqueous medium containing or contaminated with acrylamide, even longer treatment times are feasible, e.g., at least one day or longer.

### Temperature

The acrylamide reactivity of the persulfate or other peroxygen employed in the present invention increases as the temperature of the aqueous medium being treated is increased. An elevated treatment temperature is desirable since it is often effective for increasing the reactivity of the peroxide, providing a quicker reaction with the acrylamide in the aqueous medium being treated.

The temperature of the acrylamide-containing aqueous medium being treated should be at least 10-15° C. and is preferably in excess of 20° C., with higher (more elevated) temperatures being preferred. The temperature of the acrylamide-containing aqueous fluid or medium being treated is preferably at least 30° C., and more preferably at least 40° C. and most preferably at least 50° C. Higher or elevated treatment temperatures, which provide enhanced peroxygen reactivity, are desirable since contact residence times required for significant or complete acrylamide removal may be reduced, even when relatively low peroxygen treatment concentrations are used with the acrylamide-containing aqueous fluid.

The temperatures of some subterranean bodies of water or other aqueous fluids are at an elevated temperature, e.g., above at least 30° C., because of the depth they are located below the earth's surface. The temperature of subterranean water or other aqueous bodies increases because of the geothermal gradient, which is the natural increase in the temperature of the earth as depth increases (ambient earth temperature increase can be 1° C. per 100 feet of depth).

Such subterranean bodies of water may be natural, e.g., aquifers or geothermal water, but are more likely man-made, e.g., fracturing or treatment aqueous fluid injected into a subterranean oil or gas formation. Such subterranean aqueous bodies, with the aqueous fluid being at an elevated temperature, are particularly suited for treatment in this invention because of the excellent reactivity of the persulfate or other peroxygen, even at low concentration levels, with the acrylamide contaminant in such aqueous bodies.

### Compositions

The present invention is also directed to aqueous well treatment fluid compositions containing an acrylamide-derived polymer and a peroxygen compound, the peroxygen compound being present in an amount sufficient to remove acrylamide present or formed in a subterranean aqueous fluid body. The peroxygen compound in the composition of this invention is capable of generating free radicals and serves as the active agent for controlling and reducing the presence or formation of unwanted acrylamide monomer.

The peroxygen compound is typically present in an amount of about 1 ppm to about 1 wt %, based on the weight of the aqueous fluid composition, and more preferably, in an amount of about 100 ppm to about 0.1 wt %.

The peroxygen compound is preferably selected from the group consisting of ammonium persulfate, potassium persulfate, sodium persulfate, activated peracetic acid, hydrogen peroxide and combinations of these.

The aqueous composition of this invention is particularly suited for slickwater well treatment operations, in which the aqueous composition is a slickwater well treatment fluid that contains an acrylamide-derived polymer as a friction reducer.

Aqueous well treatment fluid compositions, including slickwater, fracturing fluids and the like, may include compounds such as demulsifiers, corrosion inhibitors, friction reducers, clay stabilizers, scale inhibitors, biocides, breaker aids, mutual solvents, alcohols, surfactants, antifoam agents, defoamers, viscosity stabilizers, iron control agents, diverters, emulsifiers, foamers, oxygen scavengers, pH control agents, buffers, and the like. Use of such fluid compositions in oil and gas field operations may result in the subterranean aqueous fluid bodies that result from such operations likewise containing these chemicals.

### Advantages—Utility

The acrylamide removal treatment of this invention has the significant advantage of requiring only dilute concentrations of persulfate or other peroxygen to effect excellent removal of acrylamide in accordance with this invention. This advantage is significant since the bodies of acrylamide-contaminated water or other aqueous fluid being treated are typically present in very large volumes, e.g., millions of gallons or liters, a factor that makes any treatment chemical or compound costly if required to be used in large amounts (i.e., at moderate or high concentrations).

The preferred peroxygens employed in the present invention, persulfates, hydrogen peroxide and peracetic acid, are noteworthy for being potent oxidizing agents, yet introducing no unwanted residues or chemical compounds into the aqueous medium being treated in this invention.

Another significant advantage of the present invention for treatment of acrylamide-containing subterranean water bodies or other aqueous fluid bodies is the fact that acrylamide monomer in such subterranean bodies is not susceptible to natural degradation and typically remains persistently present for long periods of time. The present invention thus provides a means for remediation of such subterranean aqueous fluid bodies that would otherwise present a long term risk of environmental contamination.

### EXAMPLES

The following non-limiting Examples illustrate preferred embodiments of the present invention.

### Example 1

Example 1 describes the chromatographic analysis of an acrylamide- and polyacrylamide-containing aqueous solution which was treated with ammonium persulfate, peracetic acid or hydrogen peroxide to evaluate acrylamide removal. Untreated solution was also analyzed to provide a basis for comparison.

### Procedure

The acrylamide-containing aqueous solution used in this Example 1 contained about 1.1 ppm acrylamide monomer and about 0.4 wt % polyacrylamide polymer. The acrylamide- and polyacrylamide-containing solution was treated in separate studies in this Example with (i) ammonium persulfate; (ii) peracetic acid and (iii) hydrogen peroxide, to evaluate each of these peroxygens for their efficacy on acrylamide removal under various conditions.

The acrylamide- and polyacrylamide-containing solution was prepared in the laboratory according to the following general procedure. The polyacrylamide polymer was a nonionic water-soluble polymer powder with a formula weight of about 5,000,000 (Sigma-Aldrich, St. Louis, Mo.), and the acrylamide monomer was likewise a powder (Sigma-Aldrich). The polyacrylamide and acrylamide powders were sequentially added to water that had been purified using a Milli-Q™ water purification system (Millipore, Billerica, Mass.), and were mixed for 30 minutes using a Waring™ 1 L laboratory blender. The temperature of the water during this procedure was maintained at about 20° C., and the pH value of the resulting solution was about 6-7.

The acrylamide- and polyacrylamide-containing solution prepared according to the general procedure was divided into four aliquots, placed in four beakers. The addition of the ammonium persulfate and other peroxygens was carried out by adding an appropriate amount of the peroxygen to the acrylamide- and polyacrylamide-containing solution at ambient temperature, about 20° C., in a designated beaker, with 3 minutes stirring, to prepare the following peroxygen concentrations: (i) 600 ppm ammonium persulfate; (ii) 750 ppm peracetic acid (but no activator); and (iii) 350 ppm hydrogen peroxide. The concentration or content of the peroxygens used in these studies was high enough that the dilution of the acrylamide solution by the addition of peroxygen was insignificant and could be ignored.

Each of these peroxygen-containing solutions, along with a solution sample containing no added peroxygen, was analyzed for acrylamide content via high-performance liquid chromatography (HPLC) with photodiode array detector (DAD), after the solutions had been aged at a temperature of 60° C. for 24 hours before the HPLC analysis. HPLC analysis was carried out in an Agilent HPLC column (Zorbax SB-Aq; 4.6×210 mm; 5 μm particles; part no. 883975-914) and a Phenomenex (Torrance, Calif.) guard column with security guard cartridges AQ C18 4×3.0 mm. The DAD wavelength set at 210 nm. The mobile phase was water, buffered at pH 7; flow rate was constant, at 1.5 ml/min.

Chromatogram results of the HPLC analyses are shown in the FIGURE. The top HPLC chromatogram in the FIGURE is the result for the untreated solution. This chromatogram shows the acrylamide peak (labeled peak, at 16 minutes) that is clearly evident for the untreated solution sample containing 1.1 ppm acrylamide and 0.4 wt % polyacrylamide but containing no added peroxygen.

The second HPLC chromatogram in the FIGURE is the result obtained for the solution sample treated with 600 ppm ammonium persulfate. In comparison with the first chromatogram, the absence of an acrylamide peak is noteworthy. The chromatogram for the ammonium persulfate-treated solution shows a new peak (when compared with the first chromatogram) at 8 minutes, and this peak is believed to have resulted from polyacrylamide polymer that is degraded or otherwise oxidized by the persulfate treatment.

The third HPLC chromatogram in the FIGURE is the result obtained for the solution sample treated with 750 ppm peracetic acid but no peroxygen activator or catalyst. The chromatogram result is very similar to the first chromatogram, with its similar-sized polyacrylamide peak at 16 minutes. The chromatogram results indicate that without the presence of a peroxygen activator, peracetic acid treatment of the solution sample containing 1.1 ppm acrylamide and 0.4 wt % polyacrylamide is ineffective for removing the acrylamide. Although the peracetic acid treatment without peroxygen activator was ineffective for acrylamide removal, the treatment was nevertheless observed to reduce the solution viscosity.

The fourth HPLC chromatogram in the FIGURE is the result obtained for the solution sample treated with 350 ppm hydrogen peroxide. In comparison with the first chromatogram, the absence of an acrylamide peak can be noted, just as was obtained with the ammonium persulfate-treated solution in the second chromatogram. The chromatogram for the hydrogen peroxide-treated solution shows a new peak (as does the ammonium persulfate treatment chromatogram) when compared with the first chromatogram at 8 minutes, and this peak is again believed to have resulted from polyacrylamide polymer that is degraded or otherwise oxidized by the hydrogen peroxide treatment.

One difference noted in the chromatograms of the FIGURE in the use of hydrogen peroxide as the peroxygen, as compared to ammonium persulfate, is the presence of minor peaks and a raised base-line in the 13 minute to 30 minute region of the chromatogram. The chromatogram result for the hydrogen peroxide treatment indicates that both ammonium persulfate and hydrogen peroxide are effective in removing acrylamide but suggests that ammonium persulfate treatment is preferable for avoiding formation of minor intermediate byproducts.

### Example 2

Example 2 describes screening evaluations for determining the acrylamide removal effectiveness of ammonium persulfate, peracetic acid and activated peracetic acid used to treat acrylamide- and polyacrylamide-containing aqueous solutions, at various temperatures and treatment times (post-treatment aging periods).

Screening evaluations were carried out in this Example 2 using an aqueous solution containing 30 ppm acrylamide and 0.1 wt % polyacrylamide that was prepared generally as described in Example 1. Evaluations were carried out at two temperatures, 20° C. and 60° C., and for two post-treatment aging periods, 3 hours and 24 hours, and results are reported in Table 1 below.

### Baseline Solution

In an initial baseline evaluation, aqueous solution containing 30 ppm acrylamide and 0.1 wt % polyacrylamide was evaluated using HPLC, as described in Example 1, to analyze quantitatively the amount of acrylamide in the samples after being aged at either 20° C. or 60° C. for 3 hours and for 24 hours. No peroxygen treatment was made in this initial baseline evaluation. The results shown in the first two data rows of Table 1 indicate that the acrylamide concentration measured in the solution samples at both temperatures and for both aging periods was essentially unchanged from the original concentration in the solution samples.

### Ammonium Persulfate

An evaluation was carried out next with a peroxygen treatment using 325 ppm ammonium persulfate as the peroxygen to treat aqueous solution containing 30 ppm acrylamide and 0.1 wt % polyacrylamide, the same solution used in the baseline evaluation. As in the baseline evaluation, two temperatures (20° C. & 60° C.) and for aging periods (3 hours & 24 hours) were used. The data in Table 1 for the ammonium persulfate treatment show that at 60° C. the peroxygen treatment reduced the acrylamide concentration by about 16% after three hours at 60° C. and by about 90% after 24 hours at 60° C. By contrast, the persulfate treatment at 20° C. was ineffective in reducing the acrylamide concentration in the treated solution.

A modified version of the peroxygen treatment using 325 ppm ammonium persulfate was also carried out, via the addition of a peroxygen activator, to demonstrate the benefit of the presence of a peroxygen activator. Ferrous sulfate (iron (II) sulfate) was added as a peroxygen activator or catalyst in conjunction with the 325 ppm ammonium persulfate to provide a concentration of 23 ppm Fe in the peroxygen-treated solution. The activated ammonium persulfate solution treatment evaluations were carried out as before, at 20° C. and 60° C. and for 3 & 24 hour aging periods.

The data in Table 1 for the activated ammonium persulfate treatment show that at 60° C. the activator-enhanced (with 23 ppm Fe) peroxygen treatment significantly improved the acrylamide-reducing performance of the ammonium persulfate. At the 60° C. treatment temperature, the acrylamide concentration was reduced by about 26% after three hours at 60° C. and by about 97% after 24 hours at 60° C. In addition, the activator-enhanced persulfate treatment at 20° C. was effective in reducing the acrylamide concentration in the treated solution, by 10% after 3 and 24 hours at 20° C.

Still another modified version of the peroxygen treatment using 325 ppm ammonium persulfate was carried out, via the addition of potassium chloride, to evaluate the effect of the presence of a soluble chloride salt on acrylamide removal. Potassium chloride was added in an amount of 2 wt % KCl in conjunction with the 325 ppm ammonium persulfate in this evaluation; no peroxygen activator was added. The data in Table 1 (see last two data rows for Ammonium Persulfate entries) indicate that the presence of the potassium chloride salt, at the 2 wt % concentration level used, had no apparent effect on acrylamide removal performance, as compared with the KCl-free ammonium persulfate treatment whose data are shown in the first two data rows for the Ammonium Persulfate entries.

### Peracetic Acid

Another evaluation was carried out with a peroxygen treatment using 750 ppm peracetic acid as the peroxygen (without a peroxygen activator) to treat aqueous solution containing 30 ppm acrylamide and 0.1 wt % polyacrylamide, again the same solution used in the baseline evaluation. As in the baseline evaluation, two temperatures (20° C. & 60° C.) and for aging periods (3 hours & 24 hours) were used. The results shown in Table 1 (see the first two data rows for the Peracetic Acid entries) indicate that the acrylamide concentration measured in the peracetic acid-treated solution samples at both temperatures and for both aging periods was essentially unchanged from the original concentration in the solution samples.

A modified version of the peroxygen treatment using 750 ppm peracetic acid was also carried out, via the addition of a peroxygen activator, to demonstrate the benefit of the presence of a peroxygen activator. Ferrous sulfate (iron (II) sulfate) was added as a peroxygen activator or catalyst in conjunction with the 750 ppm peracetic acid to provide a concentration of 23 ppm Fe in the peroxygen-treated solution. The activated peracetic acid solution treatment evaluations were carried out as before, at 20° C. and 60° C. and for 3 & 24 hour aging periods.

The data in Table 1 for the activated peracetic acid treatment show that at 60° C. the activator-enhanced (with 23 ppm Fe) peroxygen treatment significantly improved the acrylamide-reducing performance of the peracetic acid. The acrylamide concentration was reduced by about 32% after three hours at 60° C. and by about 94% after 24 hours at 60° C. In addition, the activator-enhanced peracetic acid treatment at 20° C. provided measurable reduction in the acrylamide concentration in the treated solution, by about 6% after three hours at 20° C. and by about 15% after 24 hours at 20° C.

Still another modified version of the peroxygen treatment using 750 ppm peracetic acid was carried out, via the addition of potassium chloride (KCl), to evaluate the effect of the presence of a soluble chloride salt on acrylamide removal. Potassium chloride was added in an amount of 2 wt % in conjunction with the 750 ppm peracetic acid, both with the peroxygen activator (23 ppm Fe) present and without a peroxygen activator. The data in Table 1 (see last four data rows for Peracetic Acid entries) indicate that the presence of the potassium chloride salt, at the 2 wt % concentration level used, had a positive effect on acrylamide removal performance, as compared with the KCl-free peracetic acid treatments whose data are shown in the first four data rows for the Peracetic Acid entries.

For the KCl-enhanced peracetic acid treatments with no peroxygen activator (i.e., ferrous sulfate), at the 60° C. treatment temperature, the acrylamide concentration was reduced by about 39% after three hours at 60° C., a removal percentage that remained the same after 24 hours at 60° C. In addition, the KCl-enhanced peracetic acid treatment at 20° C. provided measurable reduction in the acrylamide concentration in the treated solution, by about 10% after three hours at 20° C. and by about 21% after 24 hours at 20° C.

For the KCl-enhanced and activator-enhanced (i.e., ferrous sulfate) peracetic acid treatments, the acrylamide concentration reduction was similar to that obtained with the iron activator alone. At the 60° C. treatment temperature, the acrylamide concentration was reduced by about 48% after three hours at 60° C., and by about 97% after 24 hours at 60° C. Likewise, the KCl-enhanced and iron activator-enhanced peracetic acid treatment at 20° C. provided measurable reduction in the acrylamide concentration in the treated solution, by about 6% after three hours at 20° C. and by about 21% after 24 hours at 20° C.

TABLE 1
Screening Tests - Acrylamide Removal

| | | | | Post- | |
|---|---|---|---|---|---|
| | | | | Treatment | |
| | | | | Time | |
| | | | | 3 hours | 24 hours |
| | | | | Acrylamide | |
| | | | | Conc. | |
| Temperature (° C.) | Peroxygen | Fe (ppm) | KCl (%) | ppm | ppm |
| 20 | none | | | 31 | 33 |
| 60 | none | | | 31 | 33 |
| 20 | Ammonium Persulfate | | | 32 | 32 |
| 60 | Ammonium Persulfate | | | 26 | 3 |
| 20 | Ammonium Persulfate | 23 | | 28 | 28 |
| 60 | Ammonium Persulfate | 23 | | 23 | 1 |
| 20 | Ammonium Persulfate | | 2 | 31 | 32 |
| 60 | Ammonium Persulfate | | 2 | 28 | 5 |
| 20 | Peracetic Acid | | | 31 | 33 |
| 60 | Peracetic Acid | | | 31 | 32 |
| 20 | Peracetic Acid | 23 | | 29 | 28 |
| 60 | Peracetic Acid | 23 | | 21 | 2 |
| 20 | Peracetic Acid | | 2 | 28 | 26 |
| 60 | Peracetic Acid | | 2 | 19 | 19 |
| 20 | Peracetic Acid | 23 | 2 | 29 | 26 |
| 60 | Peracetic Acid | 23 | 2 | 16 | 1 |

### Example 3

Screening evaluations were carried out in this Example 3 to evaluate the effect of treatment temperature in the use of ammonium persulfate for removal of acrylamide from an acrylamide- and polyacrylamide-containing aqueous solution. Evaluations were carried out at treatment temperatures ranging from 20° C. to 100° C., for post-treatment aging periods of 1 hour, 3 hours and 24 hours. Analyses of acrylamide content were carried out via HPLC, performed generally as described in Example 1. Results are reported in Tables 2 & 3 below.

The solution preparation procedure was generally similar to that used in Example 1. The aqueous solution as initially prepared contained 9.6 ppm acrylamide and 0.1 wt % polyacrylamide (compared to 30 ppm acrylamide and 0.1 wt % polyacrylamide used in Example 2). The first set of evaluations in this Example 3, i.e., those reported in Table 2, was carried out using a peroxygen treatment concentration of 300 ppm ammonium persulfate.

The data shown in Table 2 show that the acrylamide concentration in the untreated solution (“Blank”) was not affected by and remained unchanged by either the solution temperature, over the range of 20° C. to 70° C. studied, or by the length of time at the specific temperature used, up to 24 hours.

The ammonium persulfate treatment data shown in Table 2 demonstrate that increased temperature had a direct and positive effect on the activity of the ammonium persulfate in removing acrylamide. The treatment temperature of 20° C. was too low to effect any acrylamide removal at the end of 24 hours after treatment. At treatment temperatures of 30° C. and 40° C., however, the ammonium persulfate treatment was effective in reducing acrylamide concentrations by 22% and 30%, compared to the untreated sample (Blank), after 24 hours at the respective treatment temperatures.

The ammonium persulfate treatment data shown in Table 2 confirm that at the higher temperatures studied, 50° C., 60° C. and 70° C., the increase in acrylamide removal activity was even more significant. At treatment temperatures of 50° C. and 60° C., the ammonium persulfate treatment was effective after only 3 hours in reducing acrylamide concentrations by about 15% and 19%, compared to the untreated sample (Blank), and, after 24 hours, was effective in reducing acrylamide concentrations by about 70% and 93%, compared to the untreated sample, at the respective treatment temperatures.

At 70° C., the highest temperature used in evaluation studies reported in Table 2, the ammonium persulfate treatment was highly effective in removing acrylamide: after only 3 hours at 70° C., the acrylamide was reduced by about 93%, compared to the untreated sample under the same conditions, and all of the acrylamide was removed by the ammonium persulfate treatment after 24 hours at 70° C.

TABLE 2

| | Post-Treatment | | Post-Treatment | |
|---|---|---|---|---|
| | Time = 3 hrs | | Time = 24 hrs | |
| | Blank | Ammonium | Blank | Ammonium |
| | (no | persulfate- | (no | persulfate- |
| Temp- | treatment) | treated sample | treatment) | treated sample |
| erature | Acrylamide | Acrylamide | Acrylamide | Acrylamide |
| (° C.) | (ppm) | (ppm) | (ppm) | (ppm) |
| 20 | 9.6 | 10.0 | 9.9 | 9.9 |
| 30 | 9.6 | 9.4 | 10.0 | 7.8 |
| 40 | 9.6 | 9.6 | 9.9 | 7.0 |
| 50 | 9.8 | 8.3 | 9.9 | 2.9 |
| 60 | 9.4 | 7.6 | 9.9 | 0.7 |
| 70 | 9.9 | 0.7 | 10.0 | 0.0 |

The second set of evaluations in this Example 3, i.e., those reported in Table 3, was again carried out using a peroxygen treatment concentration of 300 ppm ammonium persulfate as was used in the first set reported in Table 2, but this same ammonium persulfate treatment was used to treat a solution with a higher acrylamide concentration. This second set of evaluations differed from the first in that a much higher acrylamide concentration was present in the acrylamide-containing solution being treated and in the Blank: 67 ppm acrylamide and 0.1 wt % polyacrylamide, as compared with 9.6 ppm acrylamide and 0.1 wt % polyacrylamide in the first evaluation (Table 2) in this Example 3.

The second set of evaluations in this Example 3, reported in Table 3, was also carried out using a range of higher treatment temperatures, this time from 60° C. to 100° C. Analyses of acrylamide in the treated and untreated solutions were obtained via HPLC after 1 hour, 3 hours and 24 hours at each of the treatment temperatures studied. The trend observed in the first evaluation (Table 2 data) was again observed in this second evaluation, with higher treatment temperatures providing improved reactivity of the ammonium persulfate with the acrylamide, notwithstanding the higher concentration of acrylamide present in this second evaluation.

With no peroxygen treatment, the data shown in Table 3 again show that the acrylamide concentration in the untreated solution (“Blank”) was not affected by and remained unchanged by either the solution temperature, over the range of 60° C. to 100° C. studied, or by the length of time at the specific temperature used, up to 24 hours.

The ammonium persulfate treatment data shown in Table 3 demonstrate that increased temperature had a direct and positive effect on the activity of the ammonium persulfate in removing acrylamide, particularly at the higher temperatures of 60° C. to 100° C. used in this second evaluation.

The ammonium persulfate treatment data shown in Table 3 confirm that at the highest temperatures studied, 80° C., 90° C. and 100° C., the acrylamide removal activity was very high. At treatment temperatures of 80° C. and above, the ammonium persulfate treatment was effective in removing 99% or more of the initial acrylamide after only 1 hour following treatment.

At 60 and 70° C., the lowest temperatures used in this second evaluation study reported in Table 3, the ammonium persulfate treatment was still highly effective in removing acrylamide: after 24 hours at 60° C., the acrylamide concentration has been reduced by about 90%, compared to the untreated sample under the same conditions, and after 24 hours at 70° C. all of the acrylamide was removed by the ammonium persulfate treatment.

TABLE 3

| | | |
|---|---|---|
| | | Ammonium |
| | | persulfate- |
| | Blank | treated sample |
| Temperature | Acrylamide | Acrylamide |
| (° C.) | (ppm) | (ppm) |

Post-Treatment Time = 1 hr

| | | |
|---|---|---|
| 60 | 69.0 | 64.9 |
| 70 | 68.3 | 66.8 |
| 80 | 68.0 | 0.6 |
| 90 | 68.3 | 0.3 |
| 100 | 67.0 | 0.5 |

Post-Treatment Time = 3 hr

| | | |
|---|---|---|
| 60 | 67.8 | 56.1 |
| 70 | 67.3 | 58.3 |
| 80 | 66.5 | 0.0 |
| 90 | 67.2 | 0.0 |
| 100 | 65.9 | 0.0 |

Post-Treatment Time = 24 hrs

| | | |
|---|---|---|
| 60 | 66.9 | 6.5 |
| 70 | 66.3 | 0.0 |
| 80 | 67.1 | 0.6 |
| 90 | 68.1 | 0.0 |
| 100 | 66.4 | 0.0 |

### Example 4

Screening evaluations were carried out in this Example 4 to evaluate the ammonium persulfate treatment for acrylamide removal using an aqueous solution that replicated a well treatment solution containing a commercial friction reducer.

The friction reducer additive was Nalco ASP®-820 Multipurpose Friction Reducer (Nalco Energy Services, Sugar Land, Tex.), which contained an acrylamide-based anionic copolymer, AMPS (2-acrylamido-2-methylpropane sulfonic acid), as the active agent. The ASP®-820 formulation is believed to consist of about 20-30 wt % AMPS copolymer but normally contain no free acrylamide. Typical dosage rates are said to be 0.25 to 1.0 gallon of ASP®-820 per 1000 gallons of (aqueous) fluid (Nalco Product Bulletin PB-ASP-820, 2004).

The aqueous solution used in this Example 4 was again prepared according to the general procedure described in Example 1 and contained 38 ppm of added acrylamide, about 0.05 wt % of ASP®-820 friction reducer and 2 wt % of added KCl. In the solution prepared for this Example 4, 0.5 gm of ASP®-820 was added per 1 liter of water, approximating a concentration of about 0.5 gallon ASP®-820 per 1000 gallons of solution. The resulting aqueous solution was observed to be milky cloudy, suggesting that the aqueous medium contained undissolved or additional liquid phase components and was not a true solution.

The peroxygen treatment used in this Example 4 for acrylamide removal was 300 ppm ammonium persulfate, the same concentration as had been used in Example 3. Evaluations were carried out at treatment temperatures ranging from 20° C. to 100° C., for post-treatment aging periods of 3 hours and 24 hours. Analyses of acrylamide content were carried out via HPLC, performed generally as described in Example 1. Results are reported in Table 4 below.

The results shown in Table 4 confirm that the acrylamide-removal performance of the ammonium persulfate treatment in this evaluation of an aqueous solution containing a commercial friction reducing additive was equivalent to that obtained with the solutions in previous Examples. As in the other Examples, increased temperature was observed to have a direct and positive effect on the activity of the ammonium persulfate in removing acrylamide, with outstanding acrylamide removal being obtained at the higher temperatures of 60-100° C.

The ammonium persulfate treatment data shown in Table 4 confirm that at the highest temperatures studied, 80° C. and 100° C., the acrylamide removal activity was very high and acrylamide reductions of 99% or more were achieved after 3 hours following treatment.

At 60° C. and 70° C., the ammonium persulfate treatment was still highly effective in removing acrylamide: after 24 hours at both 60° C. and 70° C., over 98% of the initial acrylamide had been removed by the ammonium persulfate treatment. The data in Table 4 show that after 3 hours at both 60° C. and 70° C., the ammonium persulfate treatment had begun to remove acrylamide, with acrylamide reductions at that point being about 33% and 28% respectively, compared to the untreated sample under the same conditions.

At the lower temperatures of 40° C. and 50° C., the ammonium persulfate treatment was still effective in removing a portion of the acrylamide: after 24 hours at 40° C. and 50° C., acrylamide reductions were about 8% and about 39% respectively, compared to the untreated sample under the same conditions. The data in Table 4 show that a post treatment temperature of 20° C. was too low to effect any acrylamide removal at the end of 24 hours after treatment. These results are similar to those obtained in the previous Examples, which used both lower and higher concentrations of acrylamide in the solutions treated with 300 ppm ammonium persulfate.

TABLE 4

| | Post-Treatment | | Post-Treatment | |
|---|---|---|---|---|
| | Time = 3 hrs | | Time = 24 hrs | |
| | | Ammonium | | Ammonium |
| | | persulfate- | | persulfate- |
| Temp- | Blank | treated sample | Blank | treated sample |
| erature | Acrylamide | Acrylamide | Acrylamide | Acrylamide |
| (° C.) | (ppm) | (ppm) | (ppm) | (ppm) |
| 20 | 38.2 | 38.1 | 37.0 | 37.1 |
| 40 | 39.0 | 38.5 | 38.9 | 35.7 |
| 50 | 38.9 | 36.3 | 38.5 | 23.5 |
| 60 | 39.4 | 26.4 | 38.3 | 0.6 |
| 70 | 39.8 | 28.6 | 38.7 | 0.6 |
| 80 | 39.3 | 0.0 | 38.8 | 0.0 |
| 100 | 39.1 | 0.0 | 38.9 | 0.4 |

### Example 5

Screening evaluations were carried out in this Example 5 to study the effect of dosage or concentration of the ammonium persulfate used as the peroxygen treatment for removal of acrylamide from an acrylamide- and polyacrylamide-containing aqueous solution. The solution was maintained at a temperature of 60° C. for all of the evaluation studies. The solution preparation procedure was generally similar to that used in Example 1, and the aqueous solution as initially prepared contained 20 ppm acrylamide and 0.1 wt % polyacrylamide. Ammonium persulfate concentration used for the peroxygen treatment was varied in this study from 2.5 ppm to 2500 ppm (0.25 wt %).

Post-treatment aging periods of 3 hours and 24 hours at 60° C. were again used, with acrylamide analyses of the treated solution being carried out at these time points. Analyses of acrylamide content were carried out via HPLC, performed generally as described in Example 1. Results are reported in Table 5 below.

An initial baseline evaluation was carried out with no ammonium persulfate treatment (0 ppm) at a solution temperature of 60° C., the same temperature used for the ammonium persulfate addition studies. As shown by the results in the first data row of Table 5, the untreated solution exhibited no reduction in acrylamide concentration, which remained unchanged after 24 hours at 60° C.

The results shown in Table 5 confirm that increasing the ammonium persulfate concentration in the treatment of the acrylamide-containing aqueous solution had a direct and positive effect on the activity of the ammonium persulfate in removing acrylamide. At ammonium persulfate concentrations of 313 ppm and higher, all acrylamide was removed from the treated solution at 24 hours post-treatment.

Even at lower treatment concentrations of ammonium persulfate, e.g., 50 ppm and 100 ppm, the acrylamide removal after 24 hours was still significant, the acrylamide reduction being about 47% and 71% respectively for the two ammonium persulfate concentrations. At the lowest ammonium persulfate concentration, only 2.5 ppm, the acrylamide concentration reduction was still about 24%, measured 24 hours after treatment at a solution temperature of 60° C. The results of the temperature studies reported in Example 3 suggest that use of solution treatment temperatures higher than 60° C., e.g., 80° C. or higher, would likely improve the acrylamide removal performance of even very low treatment concentrations of ammonium persulfate.

TABLE 5

| Ammonium | Post-Treatment | Post-Treatment |
|---|---|---|
| Persulfate | Time = 3 hrs | Time = 24 hrs |
| Concentration | Acrylamide | Acrylamide |
| (ppm) | (ppm) | (ppm) |
| 0 | 20 | 21 |
| 2.5 | 19 | 16 |
| 50 | 19 | 11 |
| 100 | 19 | 6 |
| 313 | 14 | 0 |
| 625 | 13 | 0 |
| 1250 | 8 | 0 |
| 1875 | 2 | 0 |
| 2500 | 1 | 0 |

Solution temperature was maintained at 60° C. for all ammonium persulfate concentrations reported in Table

It will be appreciated by those skilled in the art that changes could be made to the embodiments described above without departing from the broad inventive concept thereof. It is understood, therefore, that this invention is not limited to the particular embodiments disclosed but is intended to cover modifications within the spirit and scope of the present invention as defined by the appended claims.

What is claimed is:

1. A method for removing acrylamide in an aqueous fluid body comprising contacting an aqueous fluid body contaminated with acrylamide with an aqueous treatment composition containing a peroxygen compound capable of generating free radicals for a period of time sufficient to remove at least a portion of the acrylamide in the untreated aqueous fluid.

2. The method of claim 1 wherein the peroxygen compound capable of generating free radicals is selected from the group consisting of ammonium persulfate, potassium persulfate, sodium persulfate, activated peracetic acid, hydrogen peroxide and combinations of these.

3. The method of claim 1 wherein the acrylamide-contaminated aqueous fluid body also contains an acrylamide-derived polymer.

4. The method of claim 1 wherein the peroxygen compound is used in combination with a peroxide activator.

5. The method of claim 4 wherein the peroxide activator is selected from transition metals and their compounds.

6. The method of claim 2 wherein the activated peracetic acid is activated with a peroxide activator.

7. The method of claim 6 wherein the peroxide activator is selected from transition metals and their compounds.

8. The method of claim 1 wherein sufficient peroxygen is contacted with the aqueous fluid body being treated to provide a concentration of at least about 1 ppm peroxygen compound in the treated fluid.

9. The method of claim 8 wherein sufficient peroxygen is contacted with the aqueous fluid body being treated to provide a concentration of at least about 100 ppm peroxygen compound in the treated fluid.

10. The method of claim 1 wherein the amount of peroxygen contacted with the aqueous fluid body being treated is less than about 1 wt % peroxygen compound in the treated fluid.

11. The method of claim 10 wherein the amount of peroxygen contacted with the aqueous fluid body being treated is less than about 0.1 wt % peroxygen compound in the treated fluid.

12. The method of claim 1 wherein the acrylamide concentration in the aqueous fluid after treatment is less than half of its initial concentration.

13. The method of claim 1 wherein the acrylamide concentration in the aqueous fluid after treatment is less than about 1 ppm.

14. The method of claim 1 wherein the aqueous fluid body is treated at a temperature in excess of 20° C., to increase the reactivity of the peroxygen with acrylamide in the acrylamide-contaminated aqueous fluid body being treated.

15. The method of claim 1 wherein the peroxygen-containing treatment composition is contacted with the aqueous fluid for a treatment time of at least 10 minutes.

16. The method of claim 1 wherein the aqueous fluid body is selected from the group consisting of subterranean aqueous bodies and surface aqueous bodies.

17. A method for removing acrylamide in a well treatment aqueous fluid comprising contacting a well treatment aqueous fluid containing an acrylamide-derived polymer with a peroxygen compound capable of generating free radicals for a period of time sufficient to remove at least a portion of acrylamide present or formed in the untreated aqueous fluid.

18. The method of claim 17 wherein the peroxygen compound capable of generating free radicals is selected from the group consisting of ammonium persulfate, potassium persulfate, sodium persulfate, activated peracetic acid, hydrogen peroxide and combinations of these.

19. The method of claim 17 wherein the peroxygen compound is used in combination with a peroxide activator.

20. The method of claim 19 wherein the peroxide activator is selected from transition metals and their compounds.

21. The method of claim 18 wherein the activated peracetic acid is activated with a peroxide activator.

22. The method of claim 21 wherein the peroxide activator is selected from transition metals and their compounds.

23. The method of claim 17 wherein sufficient peroxygen is contacted with the aqueous fluid body being treated to provide a concentration of at least about 1 ppm peroxygen compound in the treated fluid.

24. The method of claim 23 wherein sufficient peroxygen is contacted with the aqueous fluid body being treated to provide a concentration of at least about 100 ppm peroxygen compound in the treated fluid.

25. The method of claim 17 wherein the amount of peroxygen contacted with the aqueous fluid body being treated is less than about 1 wt % peroxygen compound in the treated fluid.

26. The method of claim 25 wherein the amount of peroxygen contacted with the aqueous fluid body being treated is less than about 0.1 wt % peroxygen compound in the treated fluid.

27. The method of claim 17 wherein the acrylamide concentration in the aqueous fluid after treatment is less than half of its initial concentration.

28. The method of claim 17 wherein the acrylamide concentration in the aqueous fluid after treatment is less than about 1 ppm.

29. An aqueous well treatment fluid composition comprising an acrylamide-derived polymer and a peroxygen compound capable of generating free radicals, the peroxygen compound being present in an amount sufficient to remove acrylamide present or formed in a subterranean aqueous fluid body.

30. The aqueous composition of claim 29 wherein the peroxygen compound is present in an amount of about 100 ppm to about 0.1 wt %.

31. The aqueous composition of claim 29 wherein the peroxygen compound capable of generating free radicals is selected from the group consisting of ammonium persulfate, potassium persulfate, sodium persulfate, activated peracetic acid, hydrogen peroxide and combinations of these.

32. The aqueous composition of claim 29 wherein the aqueous composition is a slickwater well treatment fluid containing an acrylamide-derived polymer as a friction reducer.
